(19) United States
(12) Patent Application Publication
(10) Pub. No.: US 2017/0257138 A1
(43) Pub. Date: Sep. 7, 2017

(54) SYSTEM AND METHOD FOR GENERATING OPTIMAL FREQUENCY HOPPING SEQUENCE

(71) Applicant: TEXAS INSTRUMENTS INCORPORATED, DALLAS, TX (US)

(72) Inventors: Chao-Fang Shih, Smyrna, GA (US); Ariton E. Xhafa, Plano, TX (US); Jianwei Zhou, Allen, TX (US)

(73) Assignee: Texas Instruments Incorporated, DALLAS, TX (US)

(21) Appl. No.: 15/057,155

(22) Filed: Mar. 1, 2016

(51) Int. Cl. H04B 1/713

(52) U.S. Cl. CPC H04B 1/713

(57) ABSTRACT

An optimal frequency hopping sequence (FHS) is proposed. The FHSs can be generated with low computation complexity using the disclosed FHS generation mechanism. The sequence generation according to the embodiments provides a way to generate optimal FHS when channel-number is power of 2 using only 1 sequence. This gives an efficient way to generate optimal FHSs with frequent used channel-numbers for example, channel-numbers 2, 4, 8, 16, and others. These FHSs also provide good interfering probability when channel-number is not a power of 2. This makes TSCH with blacklisting more suitable for IEEE 802.15.4e networks operating in the presence of interference due to decrease in power consumption.

### TECHNICAL FIELD

This disclosure relates generally to the field of wireless communication and particularly to wireless communication using Frequency Hopping Sequences.

### BACKGROUND

Generally, in wireless communication, standard organizations define functions of various network elements to ensure compatibility among various devices and efficient data communication. IEEE 802.15.4e is an enhanced MAC layer protocol of IEEE 802.15.4 and is designed for low power and low rate networks. It is suitable for sensor devices with resource constraints, e.g., low power consumption, low computation capabilities, and low memory. Time-Slotted Channel Hopping (TSCH) is a MAC mechanism in IEEE 802.15.4e wireless networks. In TSCH, transmission time is divided into timeslots, and every device is time-synchronized to a root node in the network and uses these timeslots to communicate/synchronize with the network. A device in the network ‘hops’ among various frequencies/channels according to a Frequency Hopping Sequence (FHS) during the timeslots. By hopping through various frequencies, wireless devices reduce the probability of transmitting data in a noisy channel. TSCH can achieve higher capacity and provide finer granularity for power savings in IEEE 802.15.4e networks.

Power consumption is important for devices such as sensor devices that communicate using IEEE 802.15.4e communication protocol. The power consumption of these devices increases when the interference in 2.4 GHz band increases, because due to the interference, packet retransmissions are increased. In some cases, due to the frequent retransmission, the power consumption can be as high as 3× comparing to the power consumption when there is no interference. To avoid the power consumption due to the interference, TSCH with channel blacklisting is proposed for IEEE 802.15.4e based networks. Channel blacklisting is an efficient way to decrease the power consumption due to interference by temporarily avoiding the use of channels that are observed to be heavily interfered. Because some channels are “blacklisted” due to the interference, the blacklisting changes the number of useable channels for wireless devices. For each useable channel-number, IEEE 802.15.4e defines default FHSs. Because the interference is an important issue and impacts power consumption, the default FHSs are designed in a way that the probability of interference between two interfering links is small; however, default FHSs are not optimal in reducing the probability of interference.

Referring to FIG. 1, the conventional spectrum usage of 2.4 GHz ISM band and the 16 channels of IEEE 802.15.4 networks is illustrated. In most communication environments, WiFi (802.11g/n-20 MHz) is typically the main source of interference. The WiFi communication generally uses channels 1, 6, and 11. As illustrated in FIG. 1, these channel cause interference with 802.15.4 transmission channels. As illustrated, typically one WiFi channel can interfere with four IEEE 802.15.4 channels. Generally, most frequently used channel-numbers are 16, 12, 8, and 4. In the default setting of IEEE 802.15.4e, wireless devices regenerate a new FHS every time the channel blacklist (i.e., the channel list that the device stops using) is updated. Generating a new FHS requires O(L) computations, where ‘L’ is the length of the FHS and is usually a large number to ensure randomness (e.g., L=511 in default FHS). The regeneration of FHS introduces large computational overhead. Because sensor devices have limited resources, a more efficient way to generate FHSs for blacklisting is needed.

### SUMMARY

In accordance with an embodiment a method is disclosed. The method comprising generating an m-sequence, selecting a physical channel number from a plurality of physical channel numbers using the m-sequence for transmission in a wireless network, and transmitting data using the selected physical channel number.

In accordance with another embodiment, an apparatus is disclosed. The apparatus includes a transceiver configured to receive and transmit data in a wireless network, a processing element coupled to the transceiver and configured to generate an m-sequence, select a physical channel number from a plurality of physical channel numbers using the m-sequence for transmission in a wireless network, and transmit data using the selected physical channel number.

### BRIEF DESCRIPTION OF THE DRAWINGS

FIG. 1, illustrates the conventional spectrum usage of 2.4 GHz ISM band and the 16 channels of IEEE 802.15.4 networks.

FIG. 2 illustrates an exemplary according to some embodiment.

FIG. 3 illustrates an exemplary block diagram according to some embodiment.

FIG. 4 illustrates the interfering probability graph derived via hamming auto-correlation of FHS with the sequence Y generated according to an embodiment.

FIG. 5 illustrates an exemplary wireless network system according to an embodiment.

FIG. 6, illustrates an exemplary low diagram of a process for generating an optimal frequency hopping sequence according to an embodiment.

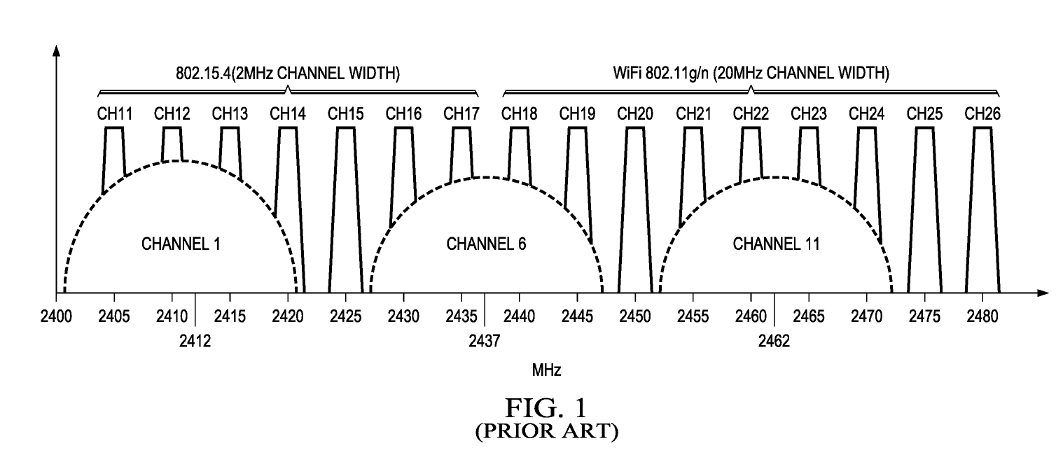

### DETAILED DESCRIPTION

The following description provides many different embodiments, or examples, for implementing different features of the subject matter. These descriptions are merely for illustrative purposes and do not limit the scope of the invention.

According to an embodiment, an optimal Frequency Hopping Sequence (FHS) is disclosed. The FHS provides optimal interfering probability for certain channels numbers (e.g., when channel numbers are 2, 4, 8, and 16) and have minimum interfering probability than conventional default FHS when the channel number is 12. These FHSs can be generated with low computation complexity using the disclosed FHS generation mechanism.

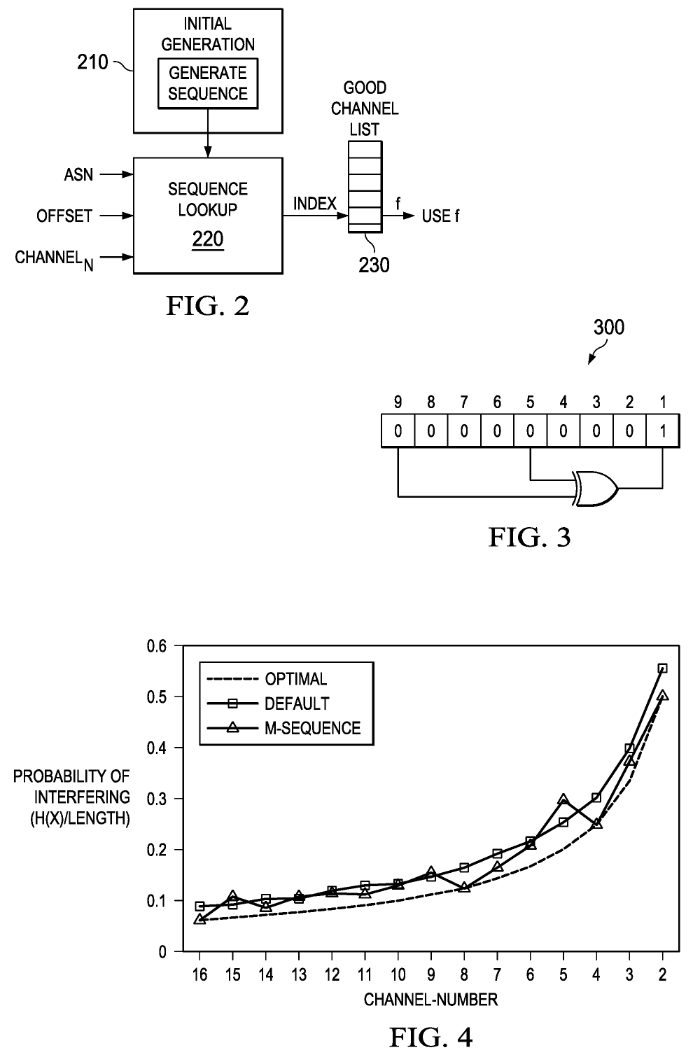

Referring to FIG. 2, a process flow for efficiently generating FHSs with different channel-numbers is illustrated according to an embodiment. Initially, without the knowledge of interfering channel numbers, a sequence is generated in sequence generation unit 210. The sequence generating unit 210 can be a hardware unit or a software module implemented in a processing unit for generating the desired sequence. The resulting sequence can be stored in a Sequence Lookup table 220 in a memory. Every time a device wants to transmit or receive, a channel index is determined to select a channel from a list of good channel number list 230. The good channel list is a list of channel number that are known to be ‘good’ for example, having minimum interference. The channel index is determined using a value in the sequence, the current channel-number Channel_{N} that was used to transmit data, the current Absolute Slot Number (ASN), and a Channel-Offset (Offset) using the equation (1) below.

Index=(Sequence[(ASN+Offset) % Sequence_Length])% Channel_{N} (Equation 1)

The ASN represents the current time slot number, which is used for synchronization with the network and the Channel-Offset is a number that is assigned to each device by the root node in the wireless network. Heavy collisions between interfering links can be avoided by assigning different Channel-Offsets to each device for transmission links. Using this approach, the need to regenerate a FHS each time the channel-number changes, can be eliminated.

According to another embodiment, a new set of FHSs can be generated with optimal interfering probability according to the known Lempel-Greenberger bound when the channel-numbers are 2, 4, 8, and 16, and have minimum interfering probability when the channel number is 12 compared to conventional default FHSs. Most importantly, these FHSs can be generated with low computation complexity using the FHS generation mechanism described herein. The FHSs generation mechanism described herein avoids the overhead of regenerating FHS when useable channel number changes. According to an embodiment, FHSs are generated with different useable channel numbers using only one initially generated sequence. Thus, the FHSs generated can have optimal (thus, minimum) interfering probability when the channel-numbers are 2, 4, 8, and 16, and have smaller interfering probability than conventional default FHS when the channel number is 12. In the conventional approach, it is challenging to generate optimal FHSs for different channel-numbers using only one sequence. Generating optimal FHSs for each channel-numbers using multiple sequences increases overhead both in memory and computation, which is not suitable for IEEE 802.15.4e networks.

According to yet another embodiment, an optimal FHS is disclosed. The optimal FHS has minimum interference probability with channel numbers are 2, 4, 8, and 16, and have minimum interfering probability than conventional default FHS when the channel number is 12. An exemplary sequence Y={y(j)} is generated using an M-sequence. M-sequence is a form of pseudorandom binary sequence and are typically generated using Linear Feedback Shift Register (LFSR), as explained below. These sequences are periodic and reproduce every binary sequence (that can be represented by the shift registers. According to an embodiment, the M-sequence is used to generate exemplary sequence ‘Y’ as M={m(j)} of degree ‘n’ over GF(p) with length q=pⁿ−1 and a k-tuples mapping a with k=n as shown below:

y(j)=M(j,k)σ=Σᵢ₌₀⁻¹m(j+i)pⁱ, 0≦j<q Equation (2)

The exemplary sequence ‘Y’ can generate optimal FHSs using equation (1) above when channel-number is power of p. Setting the power of p=2, the optimal FHSs for channel-numbers equal to 2, 4, 8, 16, and others can be generated. Following is an example that generates a sequence Y with the same length as of default FHSs (length equal to 511) using the power of p=2. An M-sequence of degree n=9 over GF(p=2) can be generated using the feedback polynomial illustrated in equation (3) below with length q=pⁿ−1=29−1=511.

f(x)=x⁹+x⁵+1 Equation (3)

Referring to FIG. 3, an exemplary Linear Feedback Shift Register (LFSR) 300 is illustrated according to an embodiment. The LFSR 300 can be any form of shift register in which the output from a standard shift register is fed back into its input in a predetermined way to cause a function to endlessly cycle through a sequence of patterns. LFSR 300 can be used to generate the M-sequence illustrated above. In the exemplary illustration, a feedback from bit 5 and bit 9 is generated for the LFSR 300.

The proposed sequence Y={y(j)} can be generated using the M-sequence illustrated above and the k-tuples mapping a in equation (2) with k=n=9 as follows:

$$y ( j ) = M ( j , k ) σ = {\sum }_{i = 0}^{9 - 1} m ( j + i ) {2}^{i} , 0 \leq j < q$$

Since the operations in computers are 2-base, the value of y(j) (i.e. the result of k-tuples mapping σ) is simply the value of viewing the whole 9 bits in LFSR as a number. Thus, the generation of the proposed sequence Y is computational efficient when p=2. Using equation (1), the following equation shows the index of FHSs generated by the proposed sequence Y as the initial generated sequence:

Index=(Y[(ASN+channelOffset) % Y_Length]) % Channel_{N} (4)

Where Y is the proposed sequence and Y_Length is the length of the proposed sequence (e.g., q=511). The FHSs generated using equation (4) with sequence Y is uniformly distributed among all good channels and optimal hamming auto-correlation (i.e. optimal interfering probability) when channel-number is equal to power of p=2 (i.e.: channel-number equal to 2, 4, 8, 16, and others). The optimality of the proposed FHSs can be proved using known theories such as for example, Theorem 1 given by Abraham Lempel and Haim Greenberger, in “Families of Sequences with Optimal Hamming Correlation Properties,” IEEE Transactions on Information Theory, January 1974. According to the Theorem 1, if M is an M-sequence of length q=pⁿ−1 over GF(p), then, for each k, let sequence Xₖ={xₖ(j)} be:

$${x}_{k} ( j ) = M ( j , k ) σ = {\sum }_{i = 0}^{k - 1} m ( j + i ) {p}^{i} , 0 \leq j < q$$

Then, Xₖ is a sequence having optimal hamming auto-correlation with length q over {0, 1, 2 . . . p^{k}−1}. The sequence Y as described herein, is equal to Xₙ, which is a sequence having optimal hamming auto-correlation with length q over {0, 1, 2 . . . pⁿ−1}.
Let Yₖ={yₖ(j)} denote the FHSs generated by equation (4) above with channel-number Channel_{N}=p^{k}. According to equation (4):

yₖ(j)=y(j)mod(p^{k})

Thus, the result is:

$${y}_{k} ( j ) = y ( j ) mod ( {p}^{k} ) = ( {\sum }_{i = 0}^{n - 1} m ( j + i ) {p}^{i} ) mod ( {p}^{k} ) \\ = ( {\sum }_{i = 0}^{n - 1} m ( j + i ) {p}^{i} ) mod ( {p}^{k} ) + ( {\sum }_{i = 0}^{k - 1} m ( j + i ) {p}^{i} ) mod ( {p}^{k} ) \\ = 0 + {\sum }_{i = 0}^{k - 1} m ( j + i ) {p}^{i} = {\sum }_{i = 0}^{k - 1} m ( j + i ) {p}^{i} \\ = {x}_{k} ( j )$$

That is, the FHSs generated by equation (4) with channel-number Channel_{N}=p^{k} is equal to Xₖ, which is a sequence having optimal hamming auto-correlation with length q over {0, 1, 2 . . . p^{k}−1}. Thus, the FHSs generated using the proposed sequence Y and equation (4) have optimal hamming auto-correlation when channel-number is power of p.

Referring to FIG. 4, the interfering probability graph derived via hamming auto-correlation of FHS with sequence ‘Y’ is illustrated according to an embodiment. The FHS is generated using equation (4) and the proposed sequence ‘Y’ generated according to an embodiment using equation (2) with a sequence length of 511. As illustrated, the proposed sequence (e.g., M-sequence) has smaller interfering probability than the conventional default FHS when channel-number is 12, good interfering probability (similar or lower than the default ones) when the channel-number is not power of 2, and optimal interfering probability when the channel-number is power of 2 (i.e. channel-number equal to 2, 4, 8, and 16).

The sequence generation according to the embodiments provides a way to generate optimal FHS when channel-number is power of 2 using only 1 sequence. This gives an efficient way to generate optimal FHSs with frequent used channel-numbers for example, channels 2, 4, 8, 16, and others. These FHSs also give good interfering probability when channel-number is not power of 2 (as illustrated in FIG. 4). This makes TSCH with blacklisting more suitable for IEEE 802.15.4e networks operating in presence of interference due to decrease in the power consumption.

The conventional FHS generating algorithms only generate one FHS each time, and each time it takes high time complexity. The sequence disclosed according to various embodiments generates a sequence that can be used by equation (1). Then, equation (1) can be used to generate multiple FHSs, each time with different channel-number with a low time complexity. The FHSs generated according to various embodiments, can have optimal interfering probability when the channel-numbers are 2, 4, 8, and 16, and have smaller interfering probability than conventional default FHSs when the channel-number is 12, and have good interfering probability (similar or lower than the default ones) with other channel numbers.

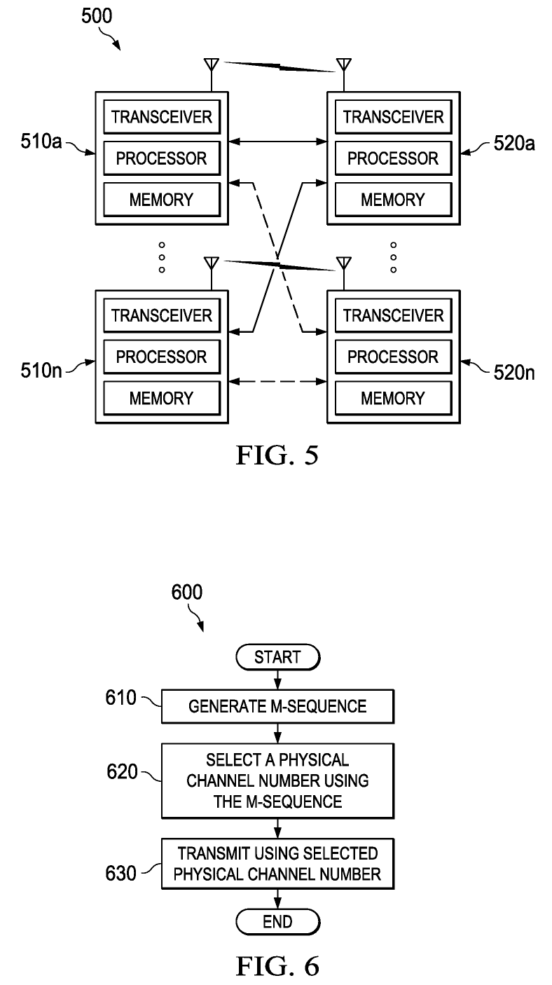

Referring to FIG. 5, an exemplary wireless network system 500 is illustrated according to an embodiment. The wireless network 500 includes wireless devices 510a-510n and 520a-520n. These devices can be any wireless devices capable of communicating with each other in the wireless network 500. While for explanation purposes, few communication links are illustrated; however, each device can communicate with every other device in the wireless network 500. The wireless device can communicate using various wireless communication protocols. According to an embodiment, the wireless devices communicate using IEEE 802.15.4e protocol using frequency hopping sequences. Each wireless device 510 and 520 further include processors, memories, transceivers, antennas, and other sub-elements (not shown) that may be needed to enable these devices to perform intended functions and communicate in the wireless network. For explanation purposes, only limited subunits for each wireless device are illustrated; however, each of the wireless devices may further include user interfaces, peripheral devices, additional subunits, and the like.

FIG. 6, illustrates a flow diagram 600 for generating an optimal frequency hopping sequence according to an embodiment. Initially an M-sequence is generated at 610 using various embodiments described herein such as for example using Equation 2. The M-sequence may be used to select a physical channel number at 620, such as for example, using Equation 1 from a list of available physical channels. The selected physical channel will have the optimal interference probability. At 630, data is transmitted using the selected physical channel.

The foregoing outlines features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims. Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method comprising:
generating an m-sequence;
selecting a physical channel number from a plurality of physical channel numbers using the m-sequence for transmission in a wireless network; and
transmitting data using the selected physical channel number.

2. The method of claim 1, wherein the physical channel number is selected based at least on one or more of:
an absolute timeslot number for transmission;
a channel offset;
a length of the m-sequence; and
a current channel-number.

3. The method of claim 1, wherein the m-sequence is generated using a linear feedback shift register.

4. The method of claim 3, wherein the linear feedback shift register is a 9-bit linear feedback shift register.

5. The method of claim 4, wherein the 9-bit linear feedback shift register generates a feedback at bits 5 and 9.

6. The method of claim 2, wherein the length of the m-sequence is 511.

7. The method of claim 1, wherein the m-sequence is a ninth sequence.

8. The method of claim 1, further comprising:
generating a frequency hopping sequence of physical channel numbers, using the m sequence, for transmission in the wireless network;
selecting a physical channel number from the frequency hopping sequence for transmission in the wireless network; and
transmitting data using the physical channel number selected from the frequency hopping sequence.

9. The method of claim 1, wherein the wireless network is an IEEE 802.15.4 network.

10. An apparatus comprising:
a transceiver configured to receive and transmit data in a wireless network; and
a processing element coupled to the transceiver and configured to generate an m-sequence,
select a physical channel number from a plurality of physical′channel numbers using the m-sequence for transmission in the wireless network, and
transmit data using the selected physical channel number.

11. The apparatus of claim 10, wherein the physical channel number is selected based at least on one or more of:
an absolute timeslot number for transmission;
a channel offset;
a length of the m-sequence; and
a current channel number.

12. The apparatus of claim 10, wherein the processing element comprising:
a linear feedback shift register, wherein the m-sequence is generated using the linear feedback shift register

13. The apparatus of claim 12, wherein the linear feedback shift register is a 9-bit linear feedback shift register.

14. The apparatus of claim 13, wherein the 9-bit linear feedback shift register generates a feedback at bit 5 and bit 9.

15. The apparatus of claim 10, wherein the length of the m-sequence is 511.

16. The apparatus of claim 10, wherein the m-sequence is a ninth degree sequence.

17. The apparatus of claim 10, wherein the processing element is further configured to:
generate a frequency hopping sequence of physical channel numbers using the m-sequence for transmission in the wireless network;
select a physical channel number from the frequency hopping sequence for transmission in the wireless network; and
transmit data using the physical channel number selected from the frequency hopping sequence.

18. The apparatus of claim 10, wherein the wireless network is an IEEE 802.15.4 network.

19. An apparatus, comprising:
sequence generating circuitry for generating an m-sequence;
selection circuitry for selecting a physical channel number from a plurality of physical channel numbers using the m-sequence for transmission in a wireless network; and
transmitter circuitry for transmitting data using the selected physical channel number.

20. The apparatus of claim 19, wherein the wireless network is an IEEE 802.15.4 network.

21. The method of claim 1, wherein the m-sequence is reused for channel lengths that are power of 2.

22. The apparatus of claim 10, wherein the m-sequence is reused for channel lengths that are power of 2.

23. The apparatus of claim 19, wherein the m-sequence is reused for channel lengths that are power of 2.

24. A method comprising:
generating a frequency hopping sequence;
selecting a physical channel number from a plurality of physical channel numbers using the frequency hopping sequence for transmission in a wireless network wherein the frequency hopping sequence is reused for channel lengths that are power of 2; and
transmitting data using the selected physical channel number.

25. An apparatus comprising:
a transceiver configured to receive and transmit data in a wireless network; and
a processing element coupled to the transceiver and configured to generate a frequency hopping sequence,
select a physical channel number from a plurality of physical channel numbers using the frequency hopping sequence for transmission in the wireless network, and
transmit data using the selected physical channel number.

26. An apparatus, comprising:
sequence generating circuitry for generating a frequency hopping sequence;
selection circuitry for selecting a physical channel number from a plurality of physical channel numbers using the frequency hopping sequence for transmission in a wireless network; and
transmitter circuitry for transmitting data using the selected physical channel number.
